(19) United States
(12) Patent Application Publication
(10) Pub. No.: US 2004/0199090 A1
(43) Pub. Date: Oct. 7, 2004

(54) Pneumatic compression system

(76) Inventors: Gerald J. Sanders, Sonoma, CA (US); Mark G. Kroot, San Francisco, CA (US)

Correspondence Address: FISH & NEAVE, 1251 AVENUE OF THE AMERICAS, 50TH FLOOR, NEW YORK, NY, 10020-1105, US

(21) Appl. No.: 10/409,779

(22) Filed: Apr. 7, 2003

(51) Int. Cl. A61H 23/02

(52) U.S. Cl. 601/149; 601/152

(57) ABSTRACT

The present invention is directed to apparatus and methods for cyclically distributing compressed air to a device, such as a therapeutic device, in a compact, cost-effective manner using a cyclic compression device having a base member. The base member preferably includes three plates, whereby an intermediate routing plate serves to route compressed air into tubing associated with the device, without the need for complex and expensive valve arrangements and pressure monitoring systems.

### FIELD OF THE INVENTION

The present invention relates to apparatus and methods for distributing compressed air to a device, and more specifically, to a relatively compact air compression system that cyclically channels compressed air to a plurality of bladders of the device without the need for complex valve arrangements and pressure monitoring systems.

### BACKGROUND OF THE INVENTION

Many subjects suffering from a number of medical conditions including, inter alia, peripheral arterial and venous disease, hypertension, diabetes and deep vein thrombosis are treated by way of therapeutic devices having one more inflatable bladders for applying a cyclic therapeutic action to a subject's lower limbs, and in particular, the subject's feet. An inflating system in fluid communication with the bladders is used to cyclically inflate and deflate the bladders.

The compressive forces provided by the inflating system may be tailored for a particular application. For example, cyclic compressive forces may be applied to a subject's heel, plantar arch, metatarsals and toes to facilitate simulation of walking or running activities. By cyclically applying compressive forces to these selected regions on the underside of a subject's foot, the pressures imposed may serve to activate the muscular pump at the subject's calf, thus motivating venous blood upstream towards the subject's heart.

Sequential inflating systems that are adapted for use in conjunction with therapeutic devices commonly have several drawbacks. Such systems generally are expensive and/or bulky, typically employing complex valve arrangements and pressure monitoring systems to control the distribution of compressed air.

For example, U.S. Pat. No. 6,296,617 to Peeler et al. (Peeler) describes a sequential compression system for preventing deep vein thrombosis comprising a system controller for controlling transfers of pressurized air. The system controller controls the transfer of air to inflatable chambers during inflation cycles, and further controls venting of the pressurized site during respective deflation cycles.

The system controller described in the Peeler patent includes control means and first and second pluralities of feeder valves that are responsive to the control means for enabling and disabling transfers of air. The control means preferably is microprocessor-based and performs command and control operations based on instructions provided in the memory.

The system controller of the device described in the Peeler patent further comprises first and second intermediate valves connected between an air source and the respective first and second plurality of feeder valves. The intermediate valves are responsive to the control means as well, and enable transfer of air from the air source to the first and second plurality of feeder valves during inflation cycles, and further vent air from the feeder valves during deflation cycles.

The device described in the Peeler patent has several drawbacks. First, when the device is used in conjunction with two medical sleeves, each having four inflatable chambers, as described in the patent, it appears that at least ten valves are required to control the inflation and deflation of the eight chambers. Such an arrangement results in a relatively complex, bulky and expensive device. Additionally, several of the valves utilized, if not all, are actuated using solenoids, which further increases the cost and complexity of the unit. Finally, a microprocessor must be employed to control the opening and closing of the multiplicity of valves, thereby further adding to the cost and complexity of the unit.

In view of these drawbacks of previously known systems, it would be desirable to provide apparatus and methods for a cyclic compression device that is relatively compact and does not employ a multiplicity of valves to inflate a plurality of bladders associated with a therapeutic device.

It also would be desirable to provide apparatus and methods for a cyclic compression device that does not require a microprocessor to control inflation and deflation of each bladder of the therapeutic device.

It further would be desirable to provide apparatus and methods for a cyclic compression device having enhanced vibration dampening characteristics.

### SUMMARY OF THE INVENTION

In view of the foregoing, it is an object of the present invention to provide apparatus and methods for a cyclic compression device that is relatively compact and does not employ a multiplicity of valves to inflate a plurality of bladders associated with a therapeutic device.

It is also an object of the present invention to provide apparatus and methods for a cyclic compression device that does not require a microprocessor to control inflation and deflation of each bladder of the therapeutic device.

It is a further object of the present invention to provide apparatus and methods for a cyclic compression device having enhanced vibration dampening characteristics.

These and other objects of the present invention are accomplished by providing a cyclic compression device comprising a base member, a pump, a motor and a manifold. In a preferred embodiment, the base member comprises a top plate, an intermediate routing plate and a base plate. The intermediate routing plate is sealingly disposed between the top plate and the base plate, such that channels in the intermediate routing plate facilitate routing of compressed air in a compact manner, without the need for expensive valve arrangements.

The pump and motor preferably are mounted atop the top plate. The manifold preferably comprises an air distribution hub, an air distribution arm in communication with the distribution hub, and at least one exhaust port. The manifold is configured to be rotated by a drive arm of the motor, such that the manifold rotates atop the top plate.

At least one bore is disposed in the top plate, beneath the pump, to enable fluid communication between the pump and a channel of the intermediate routing plate. The channel preferably is formed as a grooved section of the intermediate routing plate, whereby the top plate and/or the base plate confine the compressed air and serve to route the air through the channel of the intermediate plate.

Additionally, a plurality of wells are disposed through the top plate in the vicinity of the manifold, the plurality of wells enabling fluid communication between the air distribution hub and a plurality of circuits formed in the intermediate routing plate.

In operation, the pump generates compressed air, which then is delivered to the channel formed in the intermediate routing plate. Compressed air then is routed from the channel of the intermediate routing plate to the air distribution hub of the manifold. As the manifold rotates, the air distribution arm of the manifold cyclically rotates over each of the wells, thereby distributing compressed air into each well one at a time.

Each well is coupled to a corresponding circuit formed in the intermediate routing plate. Each circuit routes the compressed air into tubing coupled to at least one inflatable bladder of at least one therapeutic device, thereby inflating at least one corresponding bladder of the therapeutic device. As the manifold continues to rotate over the top plate, the air distribution arm then distributes air to a subsequent well. The subsequent well directs the compressed air into a second circuit formed in the intermediate routing plate, which in turn inflates at least one second bladder of the therapeutic device or devices. Using such technique, one or more bladders of one or more devices may be inflated in a cyclical manner.

A first bladder may be evacuated before, during or after a subsequent bladder is inflated. Evacuation of a bladder occurs when an exhaust port of the manifold rotates over a first well in the top plate, the first well corresponding to the first bladder. Compressed air in the original circuit is allowed to escape via the exhaust port, thereby causing deflation of the first bladder. Exhaust dampening pads may be employed to dampen the exhaust as it exits the first circuit. Either before, during or after the first bladder is evacuated, the air distribution arm may be aligned with a subsequent bladder, thereby allowing inflation of the subsequent bladder.

Using the cyclic compression device of the present invention, complex valve arrangements, as well as related actuation mechanisms and microprocessors, are eliminated.

The pressure applied to each bladder of the therapeutic device may be varied by varying the size of each air distribution well, or by varying the configuration of the air distribution circuits. Specifically, increasing the size of the air distribution wells or the area of the circuits will enable an increased flow potential, thereby increasing pressure in a corresponding bladder of the therapeutic device.

Additionally, the duration for which each bladder is inflated may be varied by varying a longitudinal length of a well or recess associated with the well, i.e., because a well having a greater length will be in fluid communication with the air distribution arm of the manifold for an increased time, thereby inflating the bladder for a greater duration.

In addition, a user may vary the speed of rotation of the motor, e.g., using an external switch, thereby causing the manifold to inflate and deflate each bladder at an increased or decreased cyclical rate.

The apparatus and methods for providing cyclic pneumatic compression, as set forth hereinbelow, may be used in conjunction with at least one therapeutic device, or any number of other devices or applications that entail cyclic inflation and deflation.

### BRIEF DESCRIPTION OF THE DRAWINGS

Further features of the invention, its nature and various advantages will be more apparent from the accompanying drawings and the following detailed description of the preferred embodiments, in which:

FIG. 1 is a schematic view of a cyclic compression device of the present invention configured to be used in conjunction with a therapeutic medical device;

FIG. 2 is a perspective view of components of the cyclic compression device of FIG. 1;

FIGS. 3A-3B are side sectional views illustrating features of the base member of FIG. 2;

FIGS. 4A-4B are side sectional views illustrating alternative base members of the present invention;

FIG. 5 is a top view of the top plate of the base member of FIG. 2;

FIGS. 6A-6B are top views of the intermediate routing plate of the base member of FIG. 2;

FIGS. 7A-7C are, respectively, a side sectional view, a top view and a bottom view of the manifold of the present invention; and

FIGS. 8A-8D describe preferred method steps for using the cyclic compression device of the present invention.

### DETAILED DESCRIPTION OF THE INVENTION

The present invention is directed to apparatus and methods for distributing compressed air to a therapeutic device in a compact, cost-effective manner using a cyclic compression device having a base member. In a preferred embodiment, the base member includes three plates, whereby an intermediate routing plate serves to route compressed air into tubing associated with the therapeutic device, without the need for complex and expensive valve arrangements and pressure monitoring systems.

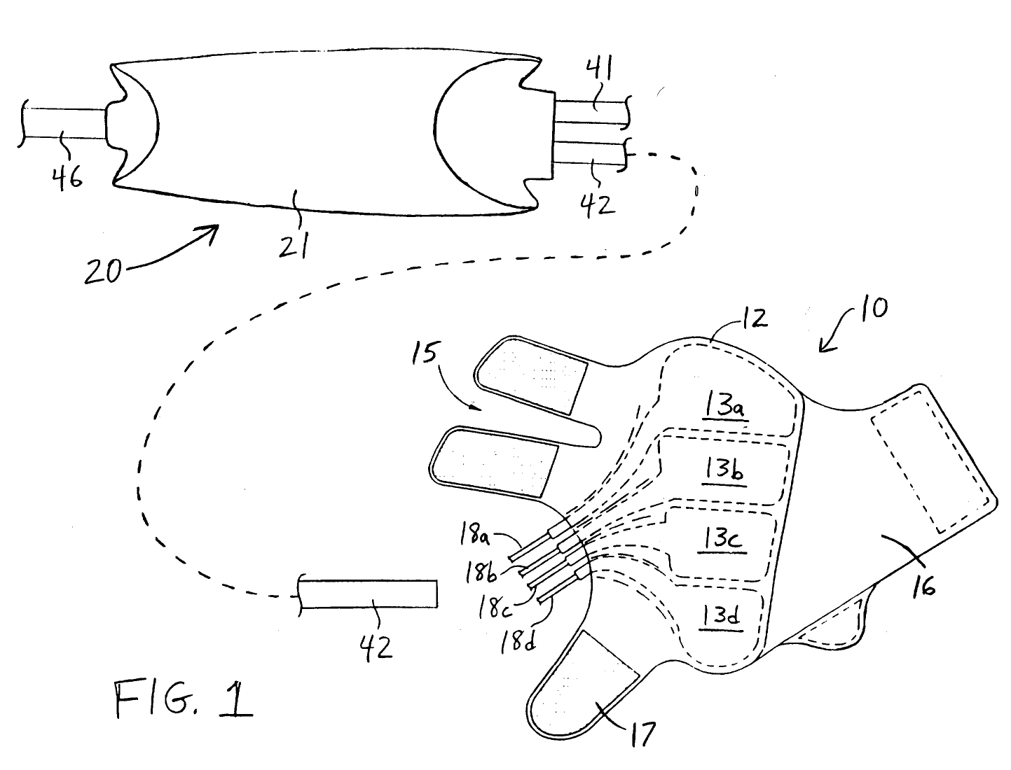

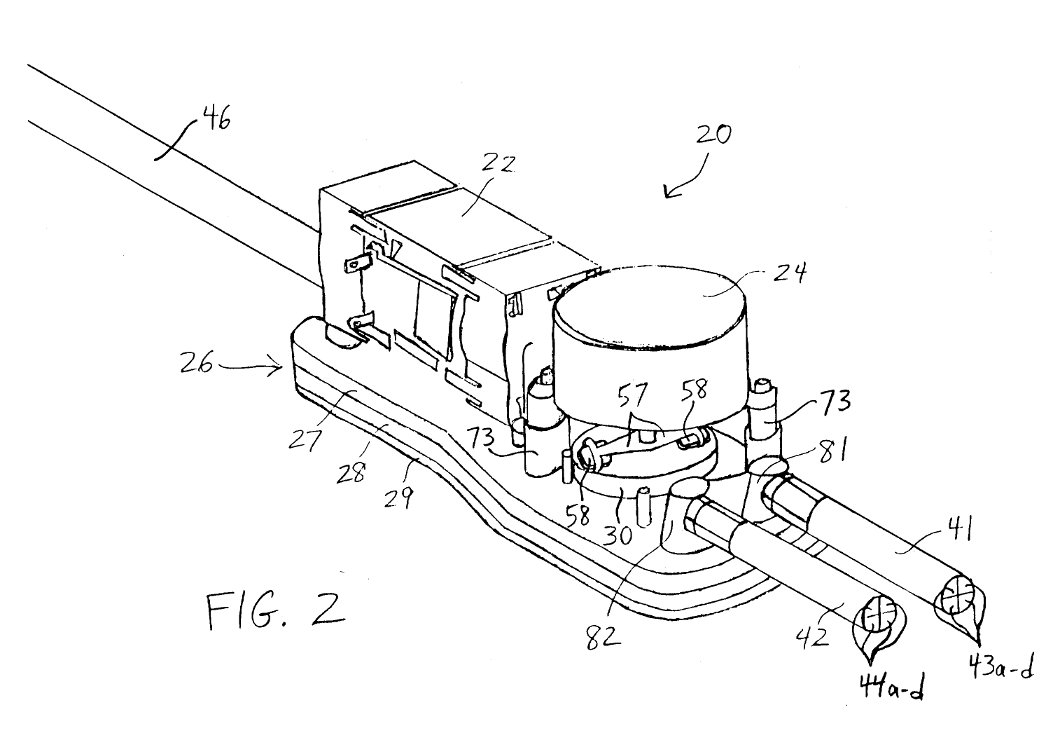

Referring now to FIG. 1, cyclic compression device 20 of the present invention is illustrated as comprising housing 21, which encloses components described hereinbelow with respect to FIG. 2. Device 20 further comprises power cord 46 and tubes 41 and 42 extending from housing 21. Cyclic compression device 20 preferably is configured to be used in conjunction with at least one therapeutic medical device 10, which is adapted to engage at least one limb of a subject for purposes of applying cyclic compression to the limb. However, it will be apparent to one skilled in the art that the apparatus and methods for providing cyclic pneumatic compression, according to principles of the present invention, may be used in conjunction with any number of other devices or applications that entail cyclic inflation and deflation, and is not intended to be limited to the exemplary medical applications described herein.

In FIG. 1, therapeutic device 10 illustratively comprises a shoe having base member 12 and plurality of inflatable bladders 13a-13d disposed thereon. Plurality of inflatable bladders 13a-13d are in fluid communication with corresponding lumens 44a-44d of tube 42 (see FIG. 2), preferably using a quick release connector (not shown) that releasably couples each lumen of tube 42 to corresponding connecting tubes 18a-18d. Therapeutic device 10 further preferably comprises vamp portions 15 and 16, and heel restraining member 17, which are configured to restrain a subject's foot so that inflatable bladders 13a-13d engage selected regions along the underside of the subject's foot.

In the embodiment of FIG. 1, tube 41 is adapted to be coupled to a first therapeutic-device (not shown), which may be similar or identical to therapeutic device 10 and is adapted to be disposed about a first limb. Tube 42 is adapted to be coupled to second therapeutic device 10, as shown in FIG. 1, which is adapted to be disposed about a second limb. It will be apparent to one skilled in the art that only one therapeutic device 10 may be utilized, and therefore, only one tube 41 or 42 may be employed. Alternatively, three or more therapeutic devices 10 may be utilized, in which case three or more tubes may be employed. It also will be apparent to one skilled in the art that cyclic compression device 20 may be coupled to any suitable therapeutic device that is adapted to apply cyclic compressive forces to a subject's limb, and is not merely intended to be used in conjunction with devices adapted to be coupled to a subject's feet, as illustratively depicted herein.

As will further be apparent to one skilled in the art, tubes 41 and 42, which illustratively comprise four lumens each (see FIG. 2), may instead comprise four separate tubes. Each tube may be individually coupled to connecting tubes 18a-18d, for example, using a quick release connector (not shown).

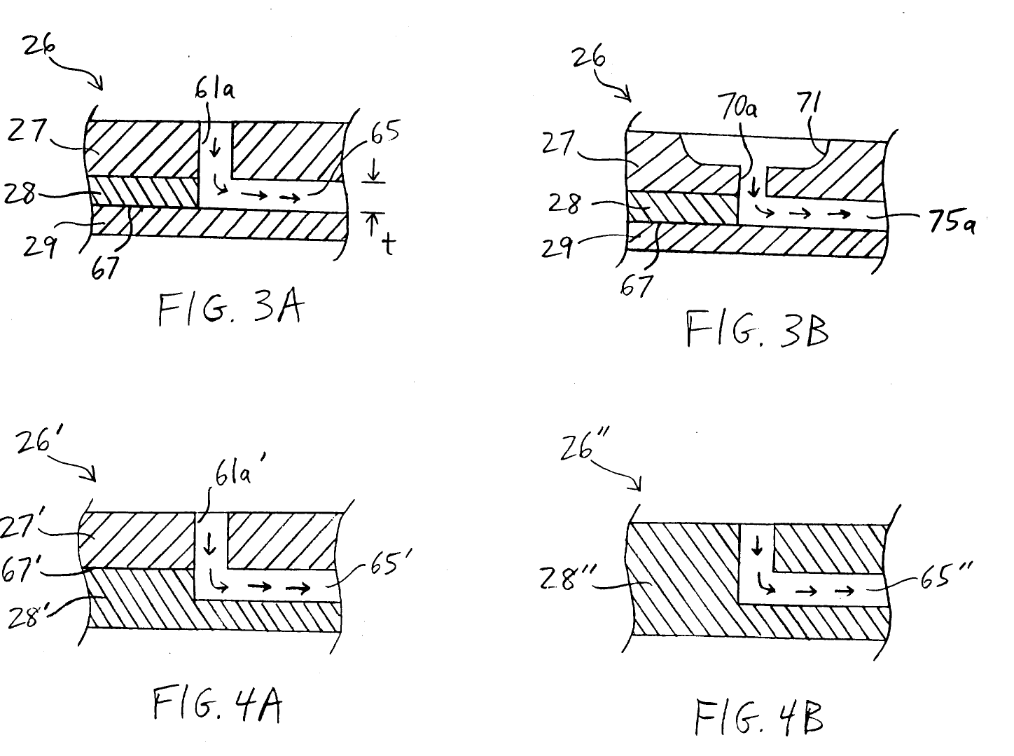

Referring now to FIG. 2, components of cyclic compression device 20 of the present invention are described. Cyclic compression device 20 preferably comprises pump 22, motor 24, base member 26 and manifold 30. Base member 26 comprises at least one plate having at least one channel configured to route compressed air, according to techniques described hereinbelow. In a preferred embodiment, base member 26 comprises top plate 27, intermediate routing plate 28, and base plate 29. In this embodiment, top plate 27 is sealingly disposed atop intermediate routing plate 28, e.g., a silastic member, and intermediate routing plate 28 is sealingly disposed atop base plate 29 to form base member 26, as illustratively shown from a side sectional view in FIGS. 3A-3B.

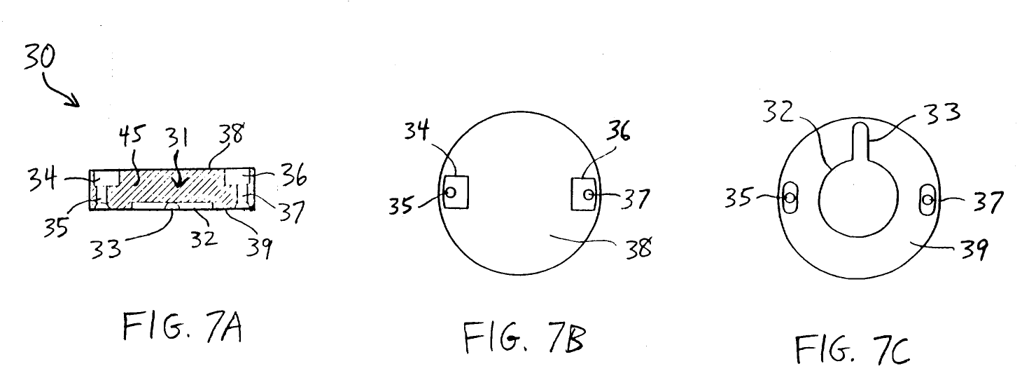

According to one aspect of the present invention, intermediate routing plate 28 comprises a plurality of channels formed therein (see FIG. 6A). The channels preferably are formed as grooved sections of intermediate routing plate 28, and the grooved sections may extend partially or fully through thickness t of plate 28 (see FIG. 3A). The grooved sections may be formed as cut-out sections of intermediate routing plate 28, or may be formed by etching, molding, stamping, die cutting or other processes that will be apparent to one skilled in the art. As will be described in greater detail hereinbelow, the plurality of channels disposed in intermediate routing plate 28 serve to route compressed air between pump 22 and tubes 41 and 42 in a compact manner, without the need for conventional valves and related actuation mechanisms.

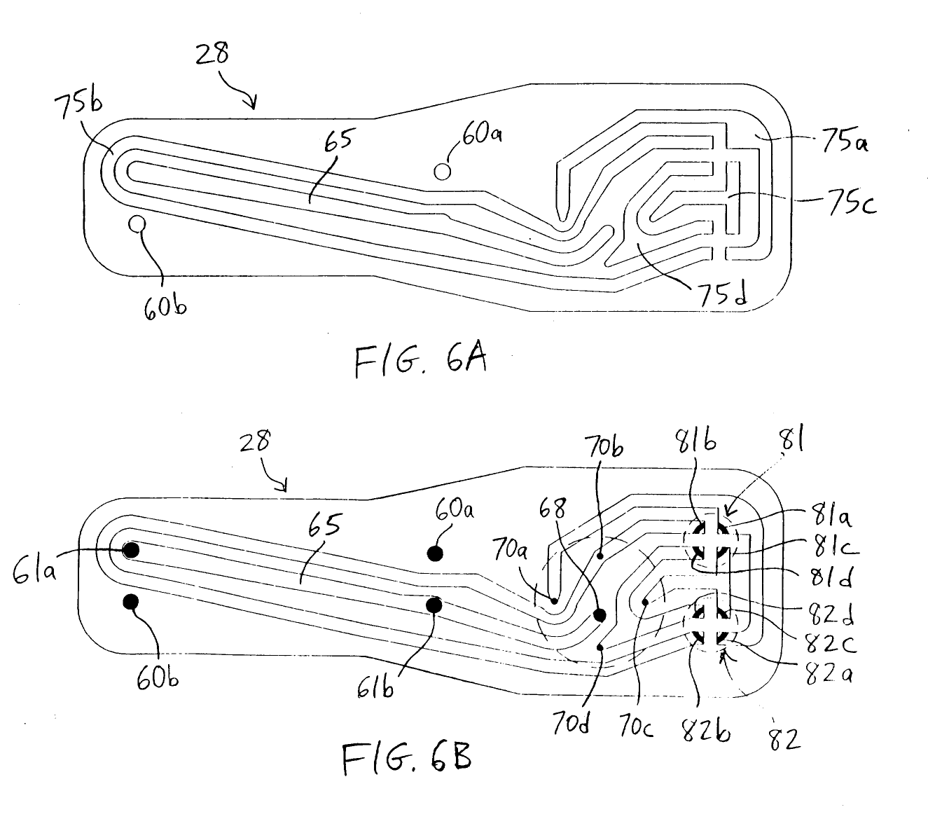

Referring now to FIG. 3A, illustrative means for routing compressed air between components mounted atop top plate 27 and intermediate routing plate 28 is described. In FIG. 3A, bore 61a is formed in a lateral surface of top plate 27. As shown in FIG. 5, bore 61a is disposed beneath pump 22, thereby enabling fluid communication between pump 22 and channel 65 of intermediate routing plate 28 for purposes described hereinbelow.

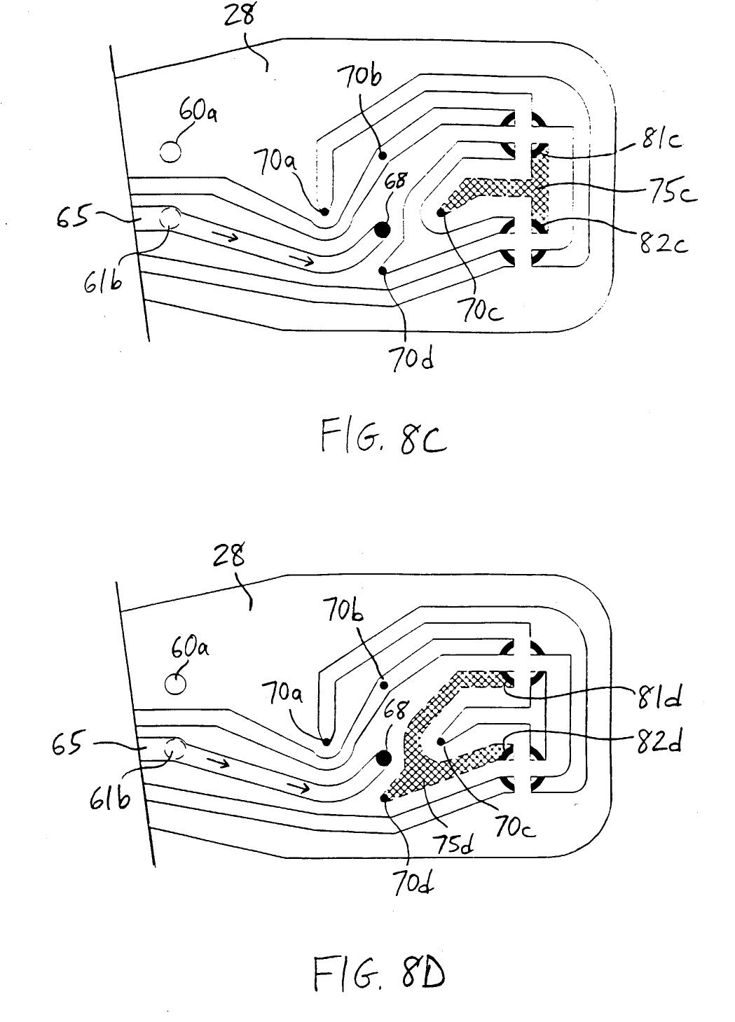

In FIG. 3B, top plate 27 further preferably includes recess 71 having bore 70a disposed therein (see also FIG. 5). As will be described hereinbelow with respect to FIG. 8A, bore 70a enables fluid communication between manifold 30 and air distribution circuit 75a of intermediate routing plate 28. Although bores 61 and 70 are depicted as substantially orthogonal to a longitudinal axis of intermediate routing plate 28, the bores may be disposed at other angles or tapered to facilitate the distribution of compressed air between components mounted atop top plate 27 and intermediate routing plate 28.

Intermediate routing plate 28 preferably comprises an elastomeric material, such as silicone, and is sized to match the configuration of top plate 27 and base plate 29. An upper surface of intermediate routing plate 28 is sealingly engaged with a lower surface of top plate 27, while a lower surface of intermediate routing plate 28 is sealingly engaged with an upper surface of base plate 29 (see FIGS. 2 and 3). Air sealing capabilities between adjacent layers of base member 26 may be enhanced using wetting agent 67, for example, silicone grease.

Intermediate routing plate 28 is sufficiently rigid that the plate will not be substantially deformed when compressed between top plate 27 and base plate 29. However, intermediate routing plate 28 also preferably is configured to be compliant to facilitate self-sealing when disposed between top plate 27 and base plate 29. Moreover, the compliant nature of intermediate routing plate 28 enables vibration dampening when used as an air distribution system, as described hereinbelow.

Base plate 29 preferably comprises a substantially rigid member and provides for planar stability of base member 26. Base plate 29 further comprises at least one air intake bore 60 (see FIG. 5). Air intake bore 60 extends through base plate 29, intermediate routing plate 28, and top plate 27, and allows ambient air to enter into pump 22. Housing 21 of FIG. 1 preferably comprises a plurality of vertical base supports (not shown) affixed to an underside of the housing, as well as corresponding air inlet bores, to provide a pathway for ambient air to enter intake bore 60.

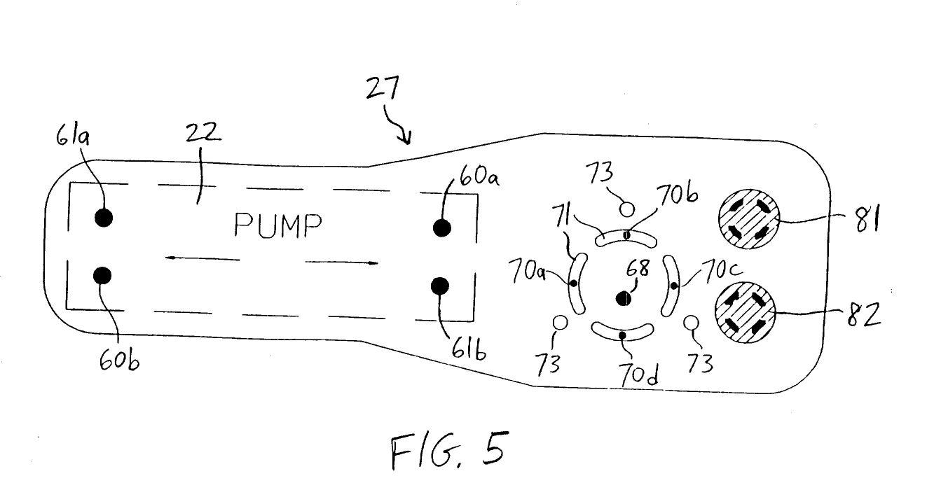

Referring now to FIGS. 4A-4B, alternative base members that may be used in conjunction with cyclic compression device 20 of the present invention are described. In FIG. 4A, alternative base member 26′ comprises top plate 27′ and intermediate routing plate 28′, which are substantially sealingly engaged together using an adhesive and/or wetting agent 67′. Intermediate routing plate 28′ comprises groove 65′, which is disposed in an upper surface of intermediate routing plate 28′, as shown in FIG. 4A. In the embodiment of FIG. 4A, intermediate routing plate 28′ serves as a routing plate to channel air, and further serves as a base plate, thereby eliminating the need for a separate base plate 29 as described in FIGS. 2-3.

Similarly, in a further alternative embodiment shown in FIG. 4B, top plate 27 and bottom plate 29 of FIGS. 2-3 are omitted. In the embodiment of FIG. 4B, intermediate routing plate 28″ having at least one channel 65″ is configured to serve as a routing plate to channel air, and further serves as a base plate and top plate.

In view of the embodiments described in FIGS. 3-4, it will be apparent to one skilled in the art that base member 26, which comprises at least one plate, may be configured to comprise any number of plates configured to route compressed air in accordance with principles of the present invention. However, due to manufacturing constraints, and to enhance structural stability, it is preferred that base member 26 employ three plates, as shown in FIGS. 3A-3B and as described herein.

Referring now to FIG. 5, features of top plate 27 are described. Top plate 27 provides a platform for mounting pump 22 and motor 24, and further comprises a multiplicity of bores disposed in the plate that are in fluid communication with channel 65 and circuits 75 of intermediate routing plate 28.

Top plate 27 preferably comprises first and second air intake bores 60a-b disposed on opposing sides of pump 22, and further preferably comprises first and second air distribution bores 61a-b disposed through top plate 27, as shown in FIG. 5. As will be apparent to one skilled in the art, the number of air intake bores 60, as well as the configuration of the intake bores, may be varied to facilitate distribution of compressed air.

In a preferred method of operation of pump 22, ambient air enters pump 22 on one side of a reciprocating piston element (not shown), for example, via air intake bore 60a. The reciprocating piston element is driven to an opposing end of pump 22 to force compressed air into air distribution bore 61a, whereby the compressed air then is directed into air distribution channel 65 of intermediate routing plate 28 (see FIG. 3A and FIG. 6B). Similarly, ambient air then enters pump 22 through air intake bore 60b, and the reciprocating piston element is driven to the opposing end of pump 22 to force compressed air into air distribution bore 61b and subsequently into channel 65 of intermediate routing plate 28. The reciprocating motion of pump 22 is repeated to provide a steady stream of compressed air into air distribution channel 65 of intermediate routing plate 28.

As will be apparent to one skilled in the art, pump 22 may comprise any other compressor known in the art that is adapted to be mounted atop top plate 27 for purposes of delivering a steady supply of compressed air to channel 65 of intermediate routing plate 28.

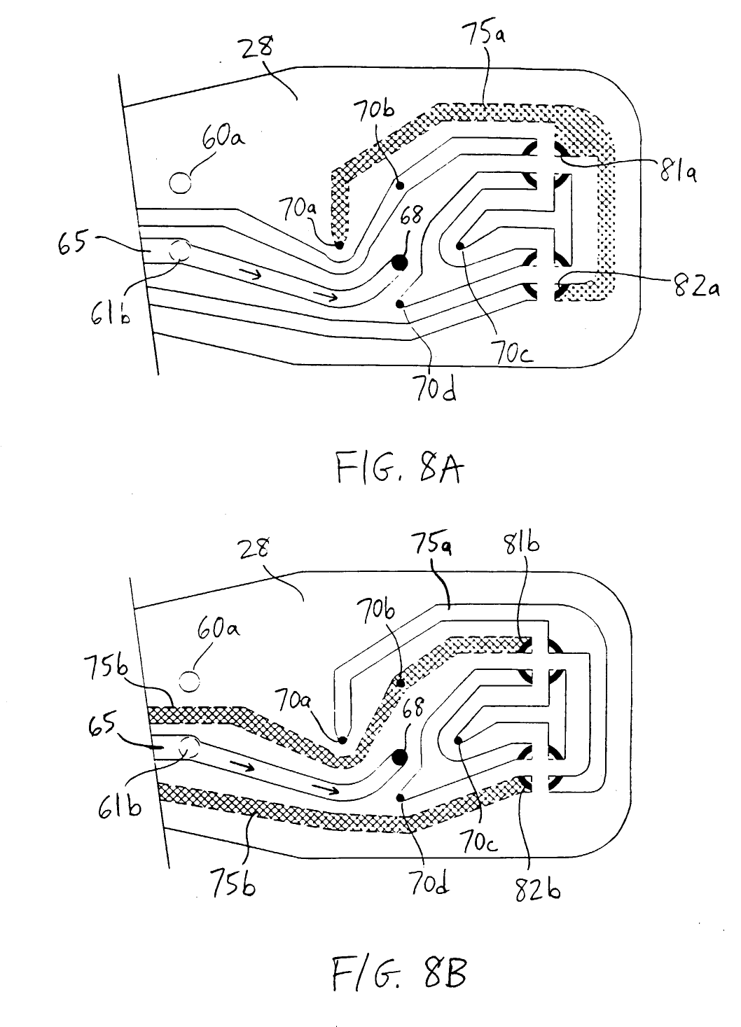

As shown in FIG. 5, top plate 27 further comprises air distribution conduit 68 extending therethrough. Air distribution conduit 68 enables fluid communication between channel 65 of intermediate routing plate 28 and hub 32 of manifold 30, as described hereinbelow with respect to FIGS. 6-7.

Referring still to FIG. 5, top plate 27 further comprises plurality of air distribution wells 70 that serve to distribute compressed air from hub 32 of manifold 30 to corresponding air distribution circuits 75, as described in detail hereinbelow. As shown in FIG. 5, and from a cross-sectional view in FIG. 3B, air distribution wells 70 preferably are at least partially surrounded by recesses 71.

In a preferred embodiment, plurality of motor supports 73 are affixed to top plate 27, as shown in FIGS. 2 and 5, to enable motor 24 and manifold 30 to overlay air distribution wells 70. As will be described hereinbelow with respect to FIGS. 8A-8D, motor drive arm 57 (see FIG. 2) engages manifold 30 and causes manifold 30 to rotate over air distribution wells 70, thereby delivering compressed air from the manifold to corresponding circuits 75 of intermediate routing plate 28.

Air distribution posts 81 and 82 preferably extend through a lateral surface of top plate 27, such that conduits of air distribution posts 81 and 82 are in fluid communication with circuits 75 of intermediate routing plate 28. As will be described hereinbelow with respect to FIGS. 8A-8D, air distribution posts 81 and 82 serve to facilitate air distribution from circuits 75 to tubes 41 and 42, respectively.

Referring now to FIGS. 6A-6B, preferred features of intermediate routing plate 28 are described in greater detail. Air distribution channel 65 and circuits 75 of plate 28 may be die cut or molded during manufacturing, as shown in FIG. 6A. Channel 65 and circuits 75 are formed as grooved sections of intermediate routing plate 28, and the grooved sections may extend partially or fully through thickness t of plate 28 (see FIG. 3A).

Channel 65 is configured so that, when intermediate routing plate 28 is sealingly disposed between top plate 27 and base plate 29, air distribution bores 61 of FIG. 5 are placed in fluid communication with channel 65. Accordingly, compressed air that exits pump 22 via air distribution bores 61 is delivered to air distribution channel 65 (for example, as depicted in FIG. 3A). Similarly, circuits 75a-75d are formed in intermediate routing plate 28 such that air distribution wells 70a-70d are placed in fluid communication with corresponding circuits 75a-75d, respectively.

It will be apparent to one skilled in the art that the configurations of air distribution channel 65 and circuits 75a-d, as well as the routing patterns depicted herein, are intended merely for purposes of illustration. The configuration of channel 65 and circuits 75a-d may be varied such that compressed air may be channeled using other any number of routing patterns formed within routing plate 28.

Referring now to FIGS. 7A-7C, features of manifold 30 of FIG. 2 are described in greater detail. Manifold 30 preferably comprises substantially circular body 31 having upper surface 38 and lower surface 39, as shown in FIG. 7A. Body 31 preferably comprises exhaust ports 34 and 36, which preferably are formed as indentations in upper surface 38. Alternatively, exhaust port 34 and/or exhaust port 36 may be partially or fully disposed in side wall 45 of body 31, as will be apparent to one skilled in the art.

Exhaust ports 34 and 36 preferably are disposed at diametrically opposing sides of body 31, as depicted in FIG. 7B. Exhaust passages 35 and 37 are in fluid communication with exhaust ports 34 and 36, respectively, and extend from their respective exhaust ports to lower surface 39 of manifold 30, as shown in FIG. 7A.

The indentations of exhaust ports 34 and 36 preferably are configured to receive exhaust dampening pads 58 of FIG. 2, and further are configured to receivingly engage opposing ends of motor drive arm 57 of FIG. 2. Accordingly, rotation of motor drive arm 57 enables rotation of manifold 30 for purposes described hereinafter.

Manifold 30 preferably further comprises air distribution hub 32, which preferably is formed as a substantially circular indentation disposed in lower surface 39, as shown in FIG. 7C. Air distribution hub 32 is in fluid communication with air distribution arm 33, which is disposed as a notch in lower surface 39. Distribution arm 33 preferably is situated at an intermediate location between exhaust passages 35 and 37, as depicted in FIG. 7C.

Lower surface 39 of manifold 30 is configured to be substantially sealingly engaged with an upper surface of top plate 27, as depicted in FIG. 2. Motor drive arm 57 preferably is spring loaded against upper surface 38 to bias lower surface 39 towards top plate 27, thereby reducing leakage of air during operation. A lubricant, for example, silicone, may be applied between manifold 30 and top plate 27 to enhance sealing characteristics.

During operation, air distribution hub 32 of manifold 30 is disposed to overlay air distribution conduit 68 of top plate 27 (see FIG. 5), thereby allowing compressed air from conduit 68 to enter air distribution hub 32. As will be described hereinbelow with respect to FIGS. 8A-8D, compressed air within air distribution hub 32 then is cyclically delivered to air distribution wells 70a-d via distribution arm 33 as the arm rotates over each well.

Referring now to FIGS. 8A-8D, a preferred method of using cyclic compression device 20 to deliver cyclical pneumatic compression waveforms to a therapeutic device is described. In a first step, described hereinabove, ambient air enters pump 22 of FIG. 2 via air intake bores 60, which extend through each of the three plates 27-29 of composite mounting plate 26. Pump 22 then compresses the ambient air and urges the compressed air into air distribution channel 65 of intermediate routing plate 28 via air distribution bores 61.

Compressed air flowing from pump 22 into air distribution channel 65 then is urged in a direction towards air distribution conduit 68, as indicated by the arrows in FIG. 8A. Air distribution conduit 68, which extends substantially vertically through top plate 27, enables compressed air from channel 65 to be collected within air distribution hub 32 of manifold 30.

During this time, motor drive arm 57, which engages exhaust ports 34 and 36 of manifold 30, causes rotation of manifold 30. As manifold 30 is rotated, air distribution arm 33 rotates over air distribution wells 70 and their respective recesses 71.

Referring still to FIG. 8A, when distribution arm 33 of manifold 30 overlays air distribution well 70a, compressed air from hub 32 is urged into well 70a. Well 70a then directs the compressed air into air distribution circuit 75a of intermediate routing plate 28. As depicted in FIG. 8A, air distribution circuit 75a in turn directs the compressed air into conduits 81a and 82a of air distribution posts 81 and 82, respectively.

Tubes 41 and 42 of FIG. 2 are coupled to air distribution posts 81 and 82, respectively, such that conduits 81a and 82a are in fluid communication with corresponding lumens of tubes 41 and 42. Accordingly, compressed air is routed from conduits 81a and 82a into lumens 43a and 44a of tubes 41 and 42, respectively.

Lumen 44a of tube 42 is in fluid communication with first bladder 13a of therapeutic device 10 of FIG. 1. The compressed air from circuit 75a inflates bladder 13a, thereby applying a compressive force to a first region of a subject's limb. As will be apparent to one skilled in the art, lumen 43a of tube 41 similarly may be coupled to another therapeutic device (not shown), similar or identical to therapeutic device 10, such that lumen 43a inflates a first bladder of the other therapeutic device.

Referring now to FIG. 8B, as motor 24 of FIG. 1 continues to drive manifold 30, distribution arm 33 rotates over air distribution well 70b. At this time, exhaust passage 35 of manifold 30 (see FIG. 7C) overlays air distribution well 70a. Additionally, exhaust passage 37 overlays well 70c.

When exhaust passage 35 overlays air distribution well 70a, compressed air is evacuated from lumens 43a and 44a, and also evacuated from first bladder 13a of therapeutic device 10. Specifically, the compressed air within circuit 75a exits the circuit through air distribution well 70a, exhaust passage 35 and exhaust port 34. Exhaust dampening pads 58 of FIG. 2, which preferably comprise felt pads, dampen the exhaust as it exits the circuit. Accordingly, air is evacuated from circuit 75a, as shown in FIG. 8B, and first bladder 13a of therapeutic device 10 is deflated.

At about the same time that first bladder 13a is deflated, second bladder 13b is inflated because distribution arm 33 overlays air distribution well 70b. Specifically, compressed air from air distribution hub 32 is directed into well 70b, then routed towards air distribution conduits 81b and 82b via circuit 75b, as shown in FIG. 8B. Compressed air that exits conduits 81b and 82b then inflates second bladder 13b of therapeutic devices 10 via corresponding lumens 43b and 44b in tubes 41 and 42, respectively.

Referring now to FIG. 8C, as motor arm 57 of FIG. 2 continues to drive manifold 30, distribution arm 33 rotates over air distribution well 70c. At this time, exhaust passage 35 of manifold 30 overlays air distribution well 70b. Additionally, exhaust passage 37 overlays well 70d.

When exhaust passage 35 overlays air distribution well 70b, second bladders 13b of therapeutic devices 10 are deflated, as described hereinabove, because air within circuit 75b exits the circuit through air distribution well 70b, exhaust passage 35 and exhaust port 34.

As second bladders 13b are deflated, third bladders 13c are inflated when distribution arm 33 overlays air distribution well 70c. Specifically, compressed air from air distribution hub 32 is directed into well 70c, then routed towards air distribution conduits 81c and 82c via circuit 75c of intermediate routing plate 28. Compressed air that exits conduits 81c and 82c then inflates third bladders 13c via corresponding lumens 43c and 44c of tubes 41 and 42, respectively.

Similarly, as manifold 30 continues to rotate, air distribution arm 33 overlays air distribution well 70d, as depicted in FIG. 8D. At this time, exhaust passage 35 of manifold 30 overlays air distribution well 70c. Additionally, exhaust passage 37 overlays well 70a. As described in detail hereinabove, this causes third bladders 13c of therapeutic devices 10 to be deflated, while fourth bladders 13d are inflated, as illustratively depicted in FIG. 8D.

The method steps described hereinabove with respect to FIGS. 8A-8D then are repeated to apply a cyclic compressive force to a subject's limb. In particular, pump 22 will continue to supply compressed air to air distribution hub 32 of manifold 30, and motor 24 will continue to drive the rotation of manifold 30 so that each bladder is inflated in sequence. As a particular bladder is inflated, the other bladders are deflated because the exhaust ports continually evacuate air from each circuit, preferably before and after each inflation cycle.

As noted hereinabove, it will be apparent to one skilled in the art that four separate tubes may be coupled to air distribution post 82, in lieu of one tube 42 having four lumens. Accordingly, each of the four separate tubes would then be coupled to a corresponding bladder of therapeutic device 10.

It will also be apparent to one skilled in the art that any number of air distribution wells, channels, and tubes may be used as needed. For example, if it is desirable that therapeutic device 10 comprise three individually inflatable bladders, then top plate 27 of cyclic compression device 20 may comprise only three air distribution wells 70, and intermediate routing plate 28 may comprise only three air distribution circuits 75 to route compressed air to three lumens coupled to the three bladders.

Advantageously, using the cyclic compression device of the present invention, complex valve arrangements, as well as related actuation mechanisms, are eliminated. Additionally, the cyclic compression device of the present invention does not require a microprocessor to control sequential inflation and deflation of the plurality of bladders associated with therapeutic device 10.

The cyclical rate for which each bladder 13a-d is inflated and deflated may be varied during operation using an external switch (not shown) that is coupled to motor 24. Specifically, a user may actuate the switch to vary the rotational speed of motor 24, which in turn causes manifold 30 to distribute compressed air to circuits 75 at faster or slower cyclical rates.

Additionally, the magnitude of pressure applied to each bladder of the therapeutic device may be varied by varying the size of each corresponding air distribution well 70, or by varying the configuration of corresponding air distribution circuits 75. For example, increasing a diameter of air distribution well 70a and/or the area of circuit 75a will increase flow through the circuit, thereby increasing pressure delivered to corresponding bladder 13a of therapeutic device 10.

Similarly, the duration for which each bladder 13 is inflated may be varied by varying the length of recesses 71. Since recesses having greater lengths will be in fluid communication with distribution arm 33 of manifold 30 for an increased time, the corresponding bladder is inflated for a greater duration.

If desired, asymmetric sequential inflation may be provided by varying the location of wells 70 and recesses 71 with respect to top plate 27, e.g., by spacing certain of wells 70 further apart from one another. For example, if it is desirable to deflate first bladder 13a for a predetermined time before inflating second bladder 13b, wells 70a and 70b may be spaced a greater distance apart on top plate 27. Accordingly, distribution arm 33 of manifold 30 will not overlay well 70b for a predetermined period of time until exhaust port 34 overlays well 70a to evacuate compressed air from the first circuit.

It also will be apparent to one skilled in the art that the location of exhaust ports 34 and 36 of manifold 30 with respect to distribution arm 33 (see FIG. 7C) may be varied to vary the sequence of inflation and deflation of adjacent bladders. For example, if exhaust passage 35 and exhaust port 34 are placed in closer proximity to distribution arm 33, then a bladder will be deflated more quickly because exhaust port 34 will evacuate the bladder shortly after distribution arm 33 enables its inflation.

Finally, it also will be apparent to one skilled in the art that the apparatus and methods for providing cyclic pneumatic compression using cyclic compression device 20, as set forth hereinabove, may be used in conjunction with other applications that employ cyclic inflation and deflation, and is not intended to be limited to the exemplary medical applications described herein.

While preferred illustrative embodiments of the invention are described above, it will be apparent to one skilled in the art that various changes and modifications may be made therein without departing from the invention. The appended claims are intended to cover all such changes and modifications that fall within the true spirit and scope of the invention.

1. Apparatus for facilitating the delivery of cyclical pneumatic compression waveforms to at least one device, the apparatus comprising:
a base member comprising at least one plate, wherein the plate comprises at least one grooved section that forms at least one air distribution circuit, wherein the air distribution circuit is in fluid communication with at least one corresponding device, and is configured to route compressed air to enable cyclic inflation and deflation of the device.

2. The apparatus of claim 1 wherein the device is a therapeutic device.

3. The apparatus of claim 1 wherein the air distribution circuit is in fluid communication with at least one corresponding bladder of the device, and is configured to route compressed air to the bladder to enable cyclic inflation of the bladder.

4. The apparatus of claim 3 wherein the base member comprises a top plate and an intermediate routing plate, the intermediate routing plate comprising the air distribution circuit, wherein the top plate is substantially sealingly engaged to the intermediate routing plate.

5. The apparatus of claim 4 wherein the intermediate routing plate comprises an elastomeric material.

6. The apparatus of claim 4 wherein the base member further comprises a base plate, wherein the base plate is substantially sealingly engaged to the intermediate routing plate.

7. The apparatus of claim 4 further comprising a pump disposed atop the top plate, wherein the pump is in fluid communication with a channel of the intermediate routing plate, the channel formed as a grooved section of the intermediate routing plate.

8. The apparatus of claim 7 further comprising:
a motor having a motor drive arm; and
a manifold having at least one air distribution arm and at least one exhaust port, the manifold disposed atop the top plate,
wherein the motor drive arm is configured to effect rotation of the manifold atop the top plate to influence the distribution of air into the air distribution circuit.

9. The apparatus of claim 8 further comprising at least one well disposed through the top plate, the well being in fluid communication with a corresponding circuit of the intermediate routing plate, wherein the distribution arm is configured to cyclically rotate over the well to cyclically route compressed air into the corresponding circuit.

10. The apparatus of claim 9 wherein the exhaust port of the manifold is configured to cyclically rotate over the well to evacuate compressed air from the corresponding circuit.

11. The apparatus of claim 10 further comprising at least one exhaust dampening pad configured to overlay the exhaust port.

12. The apparatus of claim 9 further comprising at least one recess formed in the top plate, the recess at least partially surrounding a corresponding well.

13. Apparatus for facilitating the delivery of cyclical pneumatic compression waveforms to at least one device, the apparatus comprising:
a base member;
a pump disposed atop the base member, the pump configured to generate a supply of compressed air;
a motor having a motor drive arm; and
a manifold having at least one air distribution arm and at least one exhaust port, the motor drive arm configured to effect rotation of the manifold,
wherein the base member is configured to channel compressed air from the pump to the manifold, and further configured to route compressed air from the manifold to the device.

14. The apparatus of claim 13 wherein the device is a therapeutic device.

15. The apparatus of claim 13 wherein the base member comprises at least one plate, wherein the plate comprises at least one grooved section that forms at least one air distribution circuit.

16. The apparatus of claim 15 wherein the air distribution circuit is in fluid communication with at least one corresponding bladder of the device, and is configured to route compressed air to the bladder to enable cyclic inflation of the bladder.

17. The apparatus of claim 16 wherein the base member comprises a top plate and an intermediate routing plate, the intermediate routing plate comprising the air distribution circuit, wherein the top plate is substantially sealingly engaged to the intermediate routing plate.

18. The apparatus of claim 17 wherein the base member further comprises a base plate, wherein the base plate is substantially sealingly engaged to the intermediate routing plate.

19. The apparatus of claim 18 further comprising at least one well disposed through the top plate, the well being in fluid communication with a corresponding air distribution circuit of the intermediate routing plate, wherein the distribution arm is configured to rotate over the well to route compressed air into the corresponding air distribution circuit.

20. The apparatus of claim 19 wherein the exhaust port of the manifold is configured to rotate over the well to evacuate compressed air from the corresponding air distribution circuit.

21. The apparatus of claim 20 further comprising at least one exhaust dampening pad configured to overlay the exhaust port.

22. The apparatus of claim 19 further comprising at least one recess formed in the top plate, the recess at least partially surrounding a corresponding well.

23. The apparatus of claim 18 wherein the pump is in fluid communication with a channel of the intermediate routing plate, the channel formed as a grooved section of the intermediate routing plate.

24. The apparatus of claim 18 wherein the intermediate routing plate comprises an elastomeric material.

25. A method for facilitating the delivery of cyclical pneumatic compression waveforms to at least one device, the method comprising:
providing apparatus comprising a base member, a pump disposed atop the base member, a motor having a motor drive arm and a manifold having at least one air distribution arm and at least one exhaust port, the motor drive arm configured to effect rotation of the manifold;
channeling compressed air from the pump to the manifold via the base member;
rotationally driving the manifold to distribute compressed air, via the air distribution arm, into at least one air distribution circuit disposed in the base member; and
channeling compressed air from the air distribution circuit to at least one corresponding bladder of the device to cause inflation of the corresponding bladder.

26. The method of claim 25 wherein channeling compressed air via the base member further comprises channeling the air through at least one grooved section of at least one plate of the base member.

27. The method of claim 26 wherein channeling the air through at least one grooved section of at least one plate comprises channeling the air through an intermediate routing plate that is substantially sealingly disposed between a top plate and a bottom plate.

28. The method of claim 27 further comprising:
providing at least one well disposed through the top plate, the well being in fluid communication with a corresponding air distribution circuit of the intermediate routing plate; and
varying a configuration of the well to correspondingly vary a level of pressure applied to a bladder of the device.

29. The method of claim 28 further comprising:
providing at least one recess formed in the top plate, the recess at least partially surrounding a corresponding well; and
varying a configuration of the recess to correspondingly vary a duration for which the corresponding bladder is inflated.

30. The method of claim 28 further comprising varying the locations of adjacent wells to vary a sequence of inflation associated with the bladders of the device.

31. The method of claim 25 further comprising varying a cyclical inflation rate associated with a bladder by varying a rotational speed associated with the motor.

32. The method of claim 25 further comprising evacuating the bladder by causing the exhaust port to rotate over the air distribution circuit.

33. The method of claim 25 further comprising varying a routing pattern associated with at least one of the air distribution circuits.
